(19) United States
(12) Patent Application Publication
(10) Pub. No.: US 2011/0313945 A1
(43) Pub. Date: Dec. 22, 2011

(54) CALL PUT REFERENCED STRUCTURES (CPRS)

(75) Inventor: KEVIN N. CALLAN, ALTADENA, CA (US)

(73) Assignee: RealOpts, LLC, SIERRA MADRE, CA (US)

(21) Appl. No.: 12/816,891

(22) Filed: Jun. 16, 2010

(51) Int. Cl. G06Q 40/00; G06Q 50/00

(52) U.S. Cl. 705/36 R; 705/35

(57) ABSTRACT

Computer implemented methods, systems and computer programs for creating, managing and supporting financial instruments referred to as Call Put Referenced Structures (CPRS) as provided. CPRS units are a derivative of real estate financial options and convey the right to future compensation to the CPRS owner based on CPRS algorithms used to determine the CPRS terms and values over the life of the CPRS rather than the theoretical change in market value of the subject property. The system references associated property price indices, evaluated by the system and selected by the counterparties, based on (a) the probability that the referenced property price indices rise and fall over the term of the CPRS will correlate to the rise and fall of the theoretical market value of the subject property, (b) the secondary market liquidity of the referenced indices and (c) the ability to directly or indirectly trade the referenced indices.

### FIELD OF THE INVENTION

The present invention relates generally to financial instruments related to real estate. More specifically, but not exclusively, the present invention relates to technology associated with methods and systems for receiving data associated with CPRS, computing device(s), origination, registration, servicing, clearing, settlement, pooling, trading, search and administering the system for such financial instruments.

### BACKGROUND OF THE ART

Real estate markets are an illiquid and inefficient market when compared with the debt markets that support real estate. The market value of an individual property can be unique to other properties, even in a close proximity. Real estate is not a good underlying asset for financial instruments such as options, which require homogeneity, breadth and liquidity.

Unfortunately, real estate markets have cycles just as the stock market and the bond market. Generally investors are either long or flat real estate, with little ability to hedge risk. This lack of hedging increases the boom and bust cycle for real estate. Currently the real estate market is in a down cycle and financial markets are in turmoil and unable to function efficiently. The gap between the price real estate debt owners are able to sell assets and the price that investors are willing to pay is tremendous. This gap has effectively shut down the real estate debt market and increased the liquidity premium for real estate borrowers trying to finance real estate purchases in the private sector. Millions of home owners have “negative equity” in their home, where the principal amount of mortgage debt is greater than the market value of their property. Mortgage defaults, foreclosures and distressed real estate sales are at an all time high and growing. Distressed sales are distorting the supply/demand equilibrium and creating a downward spiral for home prices and a major cause of the current liquidity crisis.

The negative impact of any downturn in the real estate market causes problems at multiple levels. Families are losing their homes, disrupting their lives and destroying their credit history. Lenders are being overwhelmed by the volume of defaults and foreclosures. The system is unable to manage the loan default process and absorb the financial costs causing many lenders' businesses to fail. Local communities are suffering as vacancies rise and property tax roll decline while the demand for public service increases. The Federal government is also impacted as it increases government spending to provide assistance to lender and property owners in an attempt to mitigate the real estate crisis.

Currently, nothing has been able to stem the tide of this market decline. One attempt at addressing these problems involves debt restructuring known as “Loan Modification”. Loan Modification is the practice of modifying the terms of a mortgage loan in an attempt to avoid default and subsequent foreclosure. The mortgagee (the lender) may change the interest rate, principal repayment schedule and/or forgive some portion on the debt. After the Loan Modification, the mortgagee recognizes the appropriate amount of economic loss and may look to the government to receive some economic relief through government sponsored programs. The homeowner may experience temporary relief, but statistically has defaulted again within months of the modification.

One problem with the current system for restructuring mortgage debt and residential real estate defaults is the tax liability property owners' face due to “phantom income” on debt forgiven. “Phantom income” occurs when money is borrowed using real estate as collateral, and not repaid. Unpaid debt is considered ordinary income regardless if the debt forgiveness occurs during a loan modification, short sale, foreclosure sale or an REO sale. Currently, some homeowners may avoid paying federal income tax for debt forgiveness that occurs prior to Jan. 1, 2013, but a large number of property owners are still subject to some form of tax payment. Beginning in 2013, all debt forgiveness will return to being taxed as ordinary income.

Another problem with the current system for restructuring mortgage debt is that the real estate lending system is financially unable to ‘write-off’ the level of debt required to resolve the current levels of negative equity. Thus, current methods of Loan Modifications and distressed real estate sales are not an effective solution.

Another attempt at solving these problems involved imbedding residential real estate calls into first mortgages during the loan modification process. Residential real estate calls are the right to the theoretical appreciation of the subject properties over a specified period of time. These calls have been used in several government sponsored modification programs, but have been received with a general lack of interest due to of the burdensome and confusing nature of the mortgage terms.

Another attempt a solving these problems involves the use of real estate option contracts, based on the theoretical change in the market value of a subject property (land and structure). The use of these options has not been able to stabilize the markets either. Real estate options on subject properties are problematic for a number of reasons. First, determining the value of the option is inefficient and problematic. Secondly, there are inherent conflicts between the subject property owner and the real estate call option owner that are unique to this type of option and make real estate options a poor investment. To accurately price the real estate option when written, over the life of the option and at expiration (or maturity) requires an accurate estimate of the market value of the subject property and an accurate history of the market values for the property in order to know the volatility of the property's price. There are several methods for estimating the market value of a subject property: appraisals, broker price opinions and electronic broker price opinions. Individually, each of these estimating methods is inefficient, even when multiple estimates are obtained at the same time using similar methodologies. For example, when real estate appraisals are required to settle an estate or during a divorce, separate real estate appraisers will often have such a wide range of estimated market values that a third appraisal is required in the hopes of narrowing the price dispersions for the same subject property. Another inefficiency in estimating the economic value of real estate is in the dispersion of the estimated values of a subject property's value when using different methodologies. The appraised value will typically be different from the broker price opinion, which is typically different from the electronic price opinion.

These inefficiencies create too great a margin of error to accurately value an option. In pricing the real estate call option using the market value of a property, an investor could hold all other pricing factors constant and the investor would still receive a significantly diverse range of values, for the same option, due to the range of estimates for the current market value of a subject property.

Another inefficiency is the low frequency of property market valuations. The low frequency causes two problems; first, option pricing models use the volatility of the market value of an asset when pricing the intrinsic and time value. Volatility is a measurement of the range of market values over time. Real estate appraisal inaccuracies and infrequent occurrences create a poor data set of market prices for a subject property. Typically, this data set will have a narrow dispersion of market values over time. The narrower the dispersion of market values for the subject property, the lower the volatility and the lower the value of the option. Secondly, to accurately value the real estate option over the life of the option, for accounting or trading purposes, an updated market value is required. Again, the estimating process is too inefficient and infrequent to provide accurate marking to market on a regular basis.

Another problem with real estate options using the value of a subject property is that there are inherent conflicts between the property owner and the option owner. The first conflict is in determining the estimated market value of the real estate when writing the option. For example, in a real estate call option, the owner of the call option has the right to the appreciated value of the subject property. When the option is originated, it is in the subject property owner's best interest to maximize the estimated value of the subject property. This will increase the value of the option and potentially decrease the intrinsic value of the option at expiration (and decrease the future liability of the property owner). Conversely it is in the best interest of the call option owner to minimize the estimated value of the subject property. This will decrease the value of the option and potentially increase the intrinsic value of the option at expiration (and increase the future income of the call option owner).

Another conflict occurs when the real estate option expires. Then it is in the best interest of the subject property owner to minimize the estimated market value of the property in order to decrease the intrinsic value of the real estate call option (and decrease the liability of the property owner). Conversely, it is in the best interest of the call option owner to maximize the estimated market value of the subject property in order to increase the intrinsic value of the real estate call option (and increase the income of the call option owner). Given the inefficiencies of estimating the market value of real estate discussed above, the likelihood for significant economic disparities at the options expiration is great. Another problem with real estate options using the market value of a subject property is that there is a conflict between the property owner and the option owner regarding property ownership rights and physical changes that occur to the subject property during the life of option. For example, in the case of a real estate call option where the option owner is entitled to the increase in the value of a subject property; it is in the best interest of the property owner to minimize (or reverse) any increase to the market value of the subject property over the life of the option. Conversely, it is in the best interest of the real estate call option owner to maximize the increase in market value of the subject property. Due to this conflict, ownership rights are ambiguous as changes made to the land or structure (good or bad) will adversely affect one party and positively affect the other. For example, it is unclear if the call option owner has the right to require the subject property owner to maintain the property, or to be compensated if deferred maintenance adversely affects the option value (market or intrinsic).

Another problem with real estate options using the value of a subject property is that there is very little legal precedent regarding liability. For example, if the option owner has an equity interest in the improvements to the property, is the option owner exposed to any financial liability associated with the subject property over the life of the option? Another problem with real estate options is that due to all the uncertainty surrounding ownership and property value, the terms of individual contracts may require to be modified over the life of the option for unforeseen situations such as permanent changes in the subject property's land or structure or changes in adjacent property.

Another problem with real estate options is that many valuation variables are local issues. Local changes that may be beyond the control of the subject property owner or the option owner's control can make significant differences in the value of the option contract. For instance, proximity to a proposed freeway will impact the equity value significantly.

Another problem is due to the problems discussed above, and others, real estate options are illiquid and difficult to sell to a third party investor thereby decreasing the desire for investors to underwrite them. Valuation problem and inefficiencies also limit the ability for investors to aggregate option contracts into pools as large numbers of contracts become too complex for investors to monitor and value.

What is needed to address these market and social dislocations are methods and systems which provide alternatives to existing mortgage defaults and debt restructuring processes and can be used to facilitate various real estate transactions. For options to work, the option writer and option owner must not have the ability to adversely affect the value of the option for the other counterparty. Third parties (accountants, regulators, investors, etc.) must be able to precisely and consistently value the option over its life, regardless of potential actions of the property owner and without the vagueness of real estate appraisals. Homogeneity and transparency are needed so that investors can manage large portfolios of contracts, or aggregate contracts into pools that can be sold to other investors. Consistent and verifiable option pricing methodologies are also a requirement for secondary market trading of option contracts and pools of contracts.

### SUMMARY OF THE INVENTION

Therefore, it is a primary object, feature, or advantage of the present invention to improve over the state of the art.

It is a further object, feature, or advantage of the present invention to provide alternatives to the current methods for mortgage defaults and debt restructuring.

Another object, feature, or advantage of the present invention is to reduce the downward spiral for home prices and the associated liquidity crisis.

Yet another object, feature, or advantage of the present invention is to provide a mechanism to stabilize the real estate markets during periods of “oversold” and “overbought” conditions by swapping mortgage debt for derivative forms of equity that are easy to understand, to value, and are marketable.

A further object, feature, or advantage of the present invention is to create a financial instrument associated with real estate which do not require the continual inspection of the subject property and where changes to the land and/or structure do not impact the intrinsic value of the option.

A still further object, feature, or advantage of the present invention is to create financial instruments based on real estate assets which do not require the estimation of the subject real estate's current market values in order to buy or sell the options in the secondary markets.

A further object, feature, or advantage of the present invention is to create a financial instrument associated with real estate which does not create ownership conflict between the writer of the option and the owner of the option, where the property owner will retain the benefits of extraordinary improvements to the subject property and the option owner can more easily project the future value(s) of their option(s).

A further object, feature, or advantage of the present invention is to create a financial instrument associated with real estate which can be used in loan modifications in a way that will allow the homeowner to minimize or avoid “debt forgiveness” and thereby avoid an income tax liability.

A further object, feature, or advantage of the present invention is to create a financial instrument associated with real estate which can be used in restructuring loan portfolios in a way that will allow the lender to minimize, or avoid, writing off mortgage debt as the lender will have received a financial instrument with an economic value approaching or equal to the amount of debt that is written off through loan modifications and distressed sales.

A further object, feature, or advantage of the present invention is to create a financial instrument associated with real estate which is easy for an investor to manage whether the investor owns a single CPRS unit, a large portfolio of CPRS units, a CPRS pool, a portion of a CPRS pool, a portfolio of CPRS pools or any combination thereof.

A still further object, feature, or advantage of the present invention is to create financial instruments based on real estate assets which can be used to narrow the gap between the price sellers of real estate assets (and real estate debt) can sell into the secondary market and the price buyers of real estate assets (and real estate debt) can pay.

A further object, feature, or advantage of the present invention is to create a financial instrument associated with real estate which can be used by individuals and institutions as an investment, a hedge or in a variety of portfolio strategies.

A still further object, feature of advantage of the present invention is that the CPRS options can be written for residential or commercial real estate.

One or more these and/or other objects, features, or advantages of the present invention will become apparent from the specification and claims that follow. The present invention is not to be limited to or by these objects, features, or advantages. Different embodiments may achieve different objects, features, or advantages.

According to one aspect of the present invention, a method for referencing a subject parcel of real estate to associated property price indices for an instrument associated with real estate is provided. The method includes receiving data associated with property price indices, statistical geographical subdivisions and the subject parcel of real estate. The data for the property price index may include current and historic values using a variety of methodologies including repeat sale price, average sale price and hedonic pricing models. The data for the statistical geographical subdivision may include geographic regions, metropolitan statistical areas, census tracts and postal codes (e.g. zip codes). The data for the subject property description may include the physical location, structural characteristics, an estimated current market value and other data used in a hedonic model. The method further provides for processing the data using a computing device to create a hedonic pricing model for the subject property, determine the statistical geographic subdivisions within each property price index, create derivative property price indices, associating the derivative property price indices with the property price indices and referencing the subject parcels of real estate to an associated property price index based on the expected correlation between the hedonic model and the associated property price indices and user preferences.

According to one aspect of the present invention, a method for calculating the option terms of an instrument associated with real estate is provided. The method includes receiving data associated with the property price indices and the user preferences. The data for the property price indices may include the current values for each property price index. The data for the user preferences may include the preferred property price index, the target intrinsic value, the time to expiration and the target premium value or the maximum acceptable Structure to Property value ratio (STV). The method further provides for processing the data using a computing device to determine the referenced property price index strike price, the expiration date, the premium value of an individual CPRS unit, the notional amount of the CPRS and the STV ratio if the user input a preference for the premium value or the CPRS premium value if the user input a preference for the STV ratio.

According to another aspect of the present invention, a method for aggregating the CPRS units into pools and aggregating CPRS units and/or pools into pools for instruments associated with real estate is provided. The method includes receiving data associated with users preferences for aggregating CPRS units and/or CPRS pools and the CPRS identifier numbers. The user preferences for may include aggregating by property price index, expiration date, intrinsic value, real estate type, real estate statistical geographical subdivision and others. The CPRS identifier numbers are unique identifies associated with each CPRS unit and CPRS pool issued. The method further provides for processing the data using a computing device to create tables for each CPRS unit in a pool and each CPRS component in a CPRS unit, aggregating CPRS components based on the user filter preferences and forming pools of CPRS components.

According to one aspect of the present invention, a method for calculating the intrinsic value of CPRS units and/or CPRS pools for an instrument associated with real estate is provided. The method includes receiving data associated with property price indices and the CPRS unit terms, or CPRS pool terms. The data for the property price indices may include the current value for each property price index that is a component of the CPRS units, or CPRS pool. The data for the CPRS unit terms, or the CPRS pool terms, include the following for each CPRS component; the notional amount, the referenced property price index strike price and the current value of the referenced property price index. The method further provides for processing the data using a computing device to create the tables for each CPRS unit in a pool and each CPRS component in a CPRS unit, calculating the intrinsic value for each CPRS component based on the change in the referenced property price index and applied to the notional amount, and aggregating the intrinsic values for each CPRS component, where the minimum intrinsic value is zero.

According to another aspect of the present invention, a method for calculating the time value of CPRS units and/or CPRS pools for an instrument associated with real estate is provided. The method includes receiving data associated with property price indices, the CPRS unit terms or the CPRS pool terms, the user preference in capital asset pricing methodology, the risk free interest rate other market data. The data for the property price indices may include the current and historical data for each index that is a component of the CPRS units or CPRS pool. The data for the CPRS unit terms, or the CPRS pool terms, include the following for each CPRS component part; the notional amount, the referenced property price index, the CPRS expiration date, the call/put indicator and the referenced property price index strike price. The method further provides for processing the data using a computing device to create the tables for each CPRS unit in a pool and each CPRS component in a CPRS unit, calculating the volatility for each property price index, calculate the time value for each CPRS component based on the notional amount of the CPRS component, the time to expiration, the call/put indicator, the referenced property price index strike price, the referenced property price index current value, the referenced property price index volatility, the risk free rate of interest and other factors as required by the user's preferred capital asset pricing model, and aggregating the time value for each CPRS component.

According to another aspect of the present invention, a system for managing financial instruments associated with derivative real estate options is provided. The system includes a computing device and a plurality of software components associated with the computing device. At least one of the pluralities of software components is configured to reference property price indices with the subject real estate parcel based on the property's location, the associated property price indices available for that location and user preferences used in administering the invention.

According to another aspect of the present invention, a system for managing financial instruments associated with derivative real estate options is provided. The system includes a computing device and a plurality of software components associated with the computing device. At least one of the pluralities of software components is configured to write the CPRS units based on the current and historic values of the referenced property price indices, the subject real estate description and user preferences used in administering the invention.

According to another aspect of the present invention, a system for managing financial instruments associated with derivative real estate options is provided. The system includes a computing device and a plurality of software components associated with the computing device. At least one of the pluralities of software components is configured to calculate the intrinsic value of the CPRS units and CPRS pools based on the current value of the CPRS component referenced property price indices and the CPRS components terms for each CPRS component used in administering the invention.

According to another aspect of the present invention, a system for managing financial instruments associated with derivative real estate options is provided. The system includes a computing device and a plurality of software components associated with the computing device. At least one of the pluralities of software components is configured to calculate the time value of the CPRS units and CPRS pools based on the current and historic values of the CPRS component referenced property price indices, the CPRS components terms, user preferences and capital markets data used in administering the invention.

According to another aspect of the present invention, a system for supporting a method of compensating counterparties when CPRS options are written is provided. The system includes a means for collecting data from a plurality of individuals wishing to write CPRS options related to real estate wherein the value of the option at the time the option is written is calculated using accurate and verifiable third party sources. The system further includes a means for collecting data from a plurality of individuals wishing to own CPRS options related to real estate. The system further includes a means for assigning a monetary value for the CPRS option based on data collected from a first set of input devices, calculating a value for the CPRS option using values of referenced property price indices, CPRS terms, market data and user preferences, presenting the CPRS option terms and the monetary values for the CPRS option to the plurality of individuals wishing to own CPRS options, and assigning the CPRS option to one of the plurality of individuals wishing to own CPRS options.

According to another aspect of the present invention, a system for supporting a method of compensating counterparties in the secondary trading of CPRS options and CPRS pools is provided. The system includes a means for collecting data from a plurality of individuals wishing to sell a CPRS option, or a CPRS pool, regarding subject option or pool wherein the value of the CPRS option or pool at the time of the trade is calculated using accurate and verifiable third party sources. The system further includes a means for collecting data from a plurality of individuals wishing to purchase a CPRS option, or a CPRS pool. The system further includes a means for assigning a monetary value for the subject CPRS option, or CPRS pool, based on data collected from a first set of input devices, calculating a value for the CPRS option, or CPRS pool, using values of referenced property price indices, CPRS terms, market data and user preferences, presenting the CPRS option, or CPRS pool's monetary values to the plurality of individuals wishing to purchase a CPRS option, or a CPRS pool, and assigning the CPRS option, or CPRS pool, to one of the plurality of individuals wishing to purchase CPRS options, or a CPRS pool.

According to another aspect of the present invention, a system for supporting the administration of the financial instruments associated with real estate is provided. The system includes a computing device and a plurality of software components associated with the computing device configured to search for and retrieve information related to referenced property price indices, CPRS units terms, pools terms, activity, history, projections, values, counterparties and other user requested statistics unique to CPRS.

According to another aspect of the present invention, a system for supporting the administration of the financial instruments associated with real estate is provided. The system includes a computing device and a plurality of software components associated with the computing device configured for the registration and safekeeping of CPRS units and CPRS pools for each counterparty.

According to another aspect of the present invention, a system for supporting the administration of the financial instruments associated with real estate is provided. The system includes a computing device and a plurality of software components associated with the computing device configured to administer the settlement of CPRS units and CPRS pools for each counterparty when CPRS options are written, aggregated into pools and traded in the secondary market.

According to another aspect of the present invention, a system for supporting the administration of the financial instruments associated with real estate is provided. The system includes a computing device and a plurality of software components associated with the computing device configured to automate, centralize, standardize and streamline processes associated with the CPRS options.

### BRIEF DESCRIPTION OF THE DRAWINGS

FIG. 1 is a block diagram illustrating a CPRS network.

FIG. 2 is a block diagram of one embodiment of a CPRS configuration.

FIG. 3 is a block diagram of the relationship between a subject real estate parcel, statistical geographic subdivisions and property price indices.

FIG. 4 is a flow chart illustrating one methodology for generating derivative property price indices.

FIG. 5 is a flow chart illustrating one methodology for calculating association between property price indices and derivative property price indices.

FIG. 6 is a flow chart illustrating one methodology for matching property price indices with statistical geographic subdivisions.

FIG. 7A is a flow chart illustrating one methodology for referencing property price indices to real estate parcels during the writing of CPRS units

FIG. 7B is a flow chart illustrating one methodology for calculating the terms of CPRS units during the writing CPRS units

FIG. 8 is a flow chart illustrating one methodology for calculating the intrinsic value, time value, market value and premium value of CPRS units

FIG. 9A is a block diagram illustrating one methodology for creating source tables for calculating the values of CPRS units.

FIG. 9B is a block diagram illustrating one methodology for creating source tables for calculating the values of a CPRS pool.

FIG. 10 is a block diagram illustrating one methodology for aggregating CPRS units and components into CPRS pools.

### DETAILED DESCRIPTION

The present invention relates generally to financial instruments related to real estate. The financial instrument is a derivative form of real estate equity that may be used to raise capital, as part of a property purchase or as part of a debt renegotiation or loan modification. According to one aspect of the present invention, the present invention provides a method of compensating the CPRS option writer (mortgagor) by the CPRS option owner (mortgagee) which involves the use of CPRS options, secured by the subject property, where the intrinsic value at expiration is based on the change in the referenced property price index and the number of CPRS units written.

For example, one type of CPRS option would be a call option, secured by the subject real estate, and based on the appreciation of the Standard and Poor's Case—Shiller Property Price Index. Of course, other property price indices, or derivatives of property price indices may be used as may be appropriate for a particular property. The CPRS option's time value is calculated using industry standard capital asset valuation methods for option pricing (e.g. Black-Sholes) modified to use the values of the referenced property price index as an alternative to the estimated theoretical market value of the subject real estate, as discussed later herein.

The CPRS premium provides economic compensation that may be used to better facilitate: loan modifications, short sales, foreclosure sales, REO sales and voluntary property sales.

The CPRS options may be secured as a lien against the real estate property, such as a first or second mortgage, or through an option trading account at a broker-dealer. Each CPRS option may be denominated in the counterparties' preferred currency and may be held as individual contracts, aggregated into pools, or placed into a trust to create asset backed securities.

According to one aspect of the present invention the use of CPRS supports the referencing, writing, pooling, secondary market and expiration activity using systems, database structures and algorithms. The information related to the options and corresponding pools may be available to option holders, writers, potential investors, and other interested third parties such as mortgage servicers, brokerage firms, exchanges, trustees and others through private and public networks.

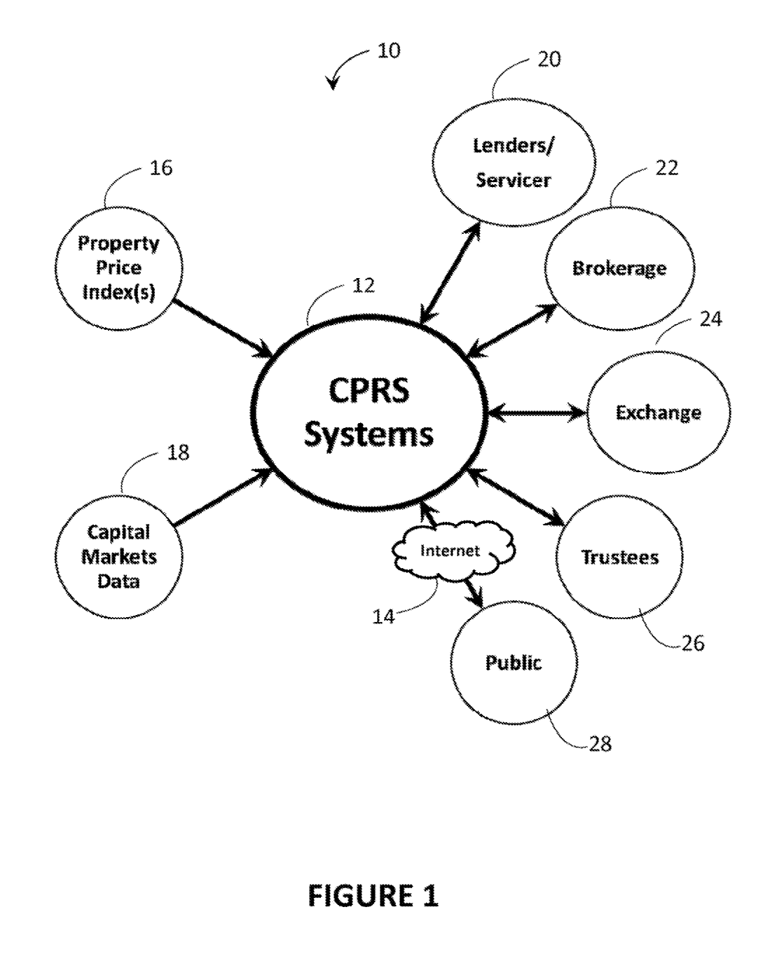

FIG. 1 illustrates one embodiment of such a network 10. In the network 10, a CPRS system 12 is shown. The CPRS system 12 is in operative communication with one or more additional systems or computing devices using private networks or public networks such as the internet 14. The CPRS system 12 is connected to service providers that transmit data, such as a property price indices (PPI) 16 and capital markets data 18. The CPRS system 12 is also connected to users that access the system to write, pool, trade, audit and for other purposes such as a lender or servicer 20, a brokerage 22, an exchange 24 and ABS trustee 26. These CPRS system may also communicate with the public 28 over a public network such as the internet 14 or otherwise.

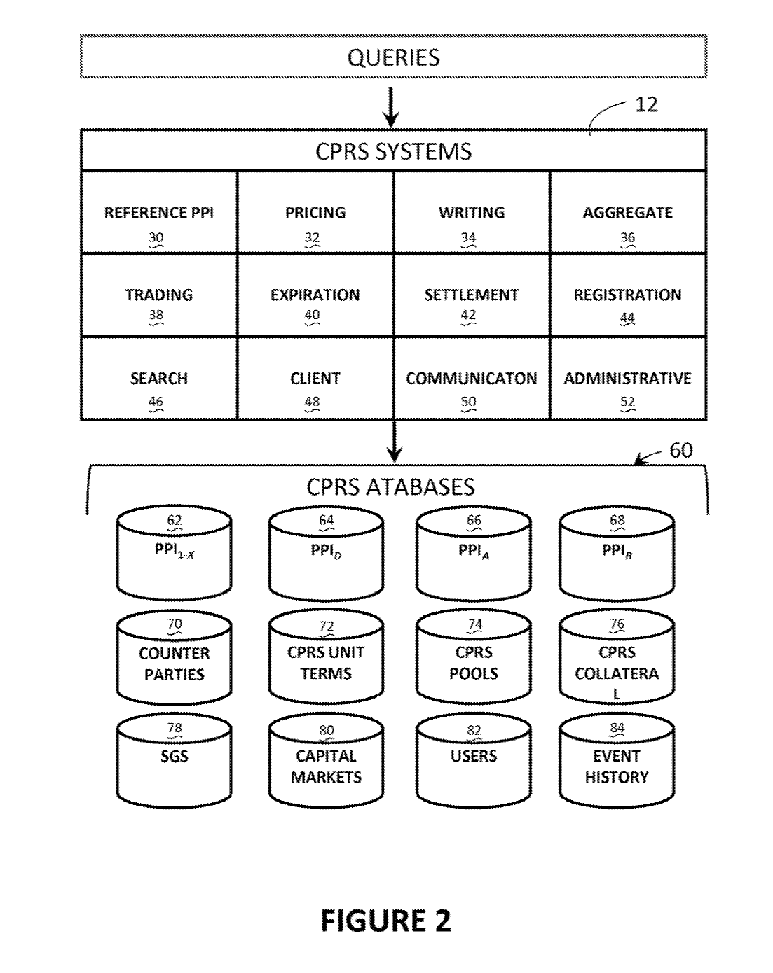

One example of a CPRS configuration is shown in FIG. 2. In FIG. 2 queries are received into the CPRS system 12. The CPRS system 12 has various components or modules for performing different functions. Examples of such components or modules include a referencing component 30, a pricing component 32, a writing component 34, an aggregating component 36, a trading component 38, an expiration component 40, a settlement component 42, a registration component 44, a search component 46, a client component 48, a communication component 50 and an administrative component 52. Each of the components or modules may be implemented in software executing on one or more computing devices. All of the components or modules may be present on a single computing device or may be distributed between multiple computing devices which may be networked together.

Information used by the CPRS systems may be stored on a computer readable storage medium such as in databases 60. The databases 60 may be implemented as multiple databases stored across multiple computing devices or may be portions of a single database associated with a single computing device. The databases include a property price indices database 62, a derivative property price indices database 64, an associated property price indices database 66, a referenced property price indices database 68, a counterparties database 70, a CPRS terms database 72, a CPRS pools database 74, a CPRS collateral database 76, a statistical geographic subdivision database 78, a capital market prices database 80, a users database 82 and an event history database 84. Of course additional databases may be present to store or collect additional data. In addition, not all databases are shown are needed for all functionalities provided by the CPRS system 12.

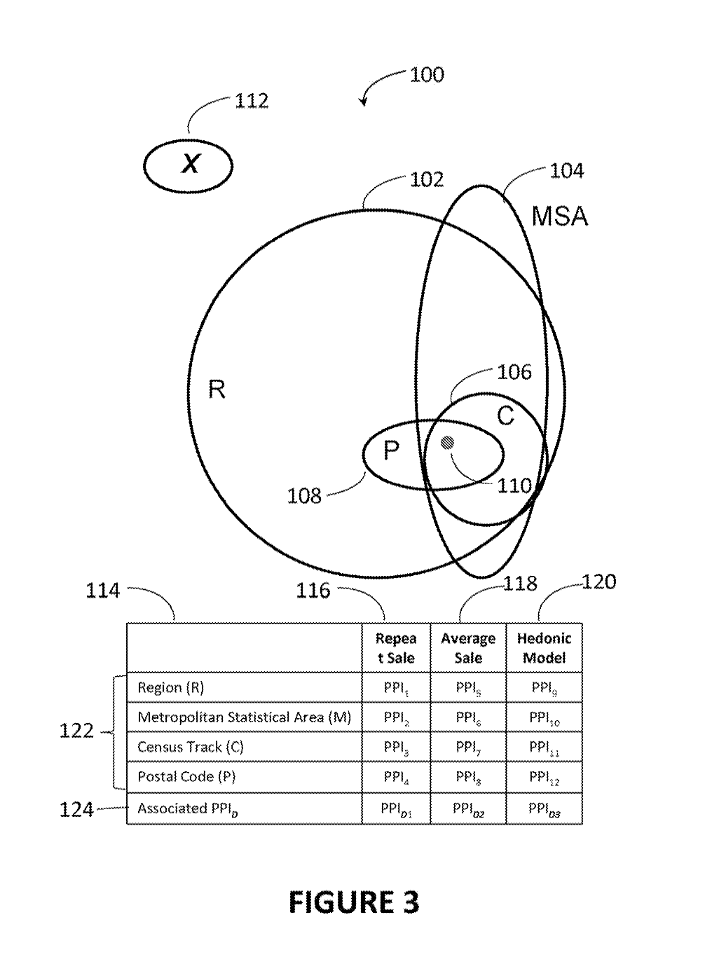

According to one aspect of the invention, the CPRS system references associated property price indices to a subject real estate parcel. This process occurs based, in part, on the statistical geographical subdivisions used in calculating the property price index and the statistical geographical subdivisions the subject property is located in. One example of these relationships is shown in FIG. 3. FIG. 3 illustrates one embodiment of this relationship 100. Statistical geographic subdivision may include geographical regions (R) 102, metropolitan statistical areas (MSA) 104, census tracts (C) 106 and postal codes, e.g. zip codes (P) 108. The subject property 110 may be located at the intersection of multiple statistical geographic subdivisions. The CPRS system 12 also associates the subject property with property price indices, and derivative property price indices from other statistical geographic subdivision 112. The reference table 114 presents a sampling of property price indices that may be reference to a subject property. The methods property price index service providers 16 use to calculate property prices may include repeat sales 116, average sale price 118 and hedonic models 120. The CPRS system 12 uses many property price indices, using a variety of methodologies, for many statistical geographic subdivisions 122 and derivative associations 124 when referencing subject properties to a particular property price index.

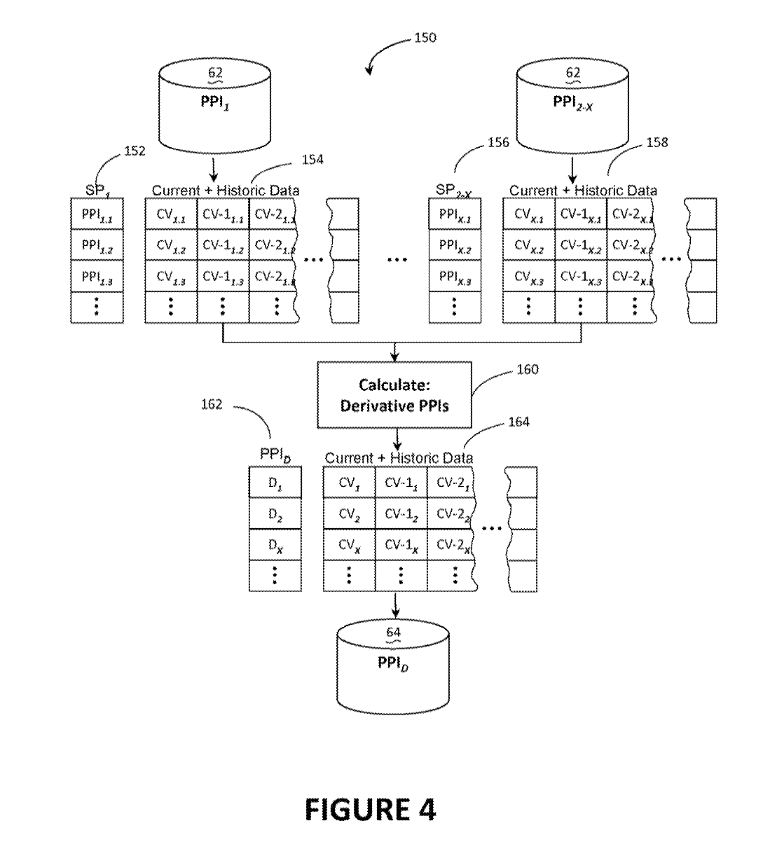

The use of a CPRS system to perform different functions is also shown in FIG. 4 through FIG. 10. These examples are merely to illustrate the performance of different functionality within a particular embodiment of the system. These examples are not intended to be limiting as the present invention contemplates numerous variations, options, and alternatives.

FIG. 4 is a flowchart that illustrates one example of how derivative property price indices 150 are created. In addition to receiving a plurality of property price indices 16 from various service providers, the CPRS system 12 creates derivative property price indices 150 that may be used as an alternative to a specific property price index 16 when referencing a subject property. The CPRS system 12 stores all of the property price indices values in database 62. The system retrieves the records for each property price index from a service provider 152. A table is created with the current and historic levels 154 of the property price index. The system then retrieves the records for all property price indices from all the property price index service providers 156. Additional tables are created with the current and historic levels 158 for all property price indices. The system then calculates derivative property price indices based on a combination of user preferences and proprietary algorithms 160. The derivative property price indices are formatted into records 162 in the same way that property price indices are received from service providers, including the theoretical current and historic values 164. The derivative property price indices are then stored in the derivative property price index database 64.

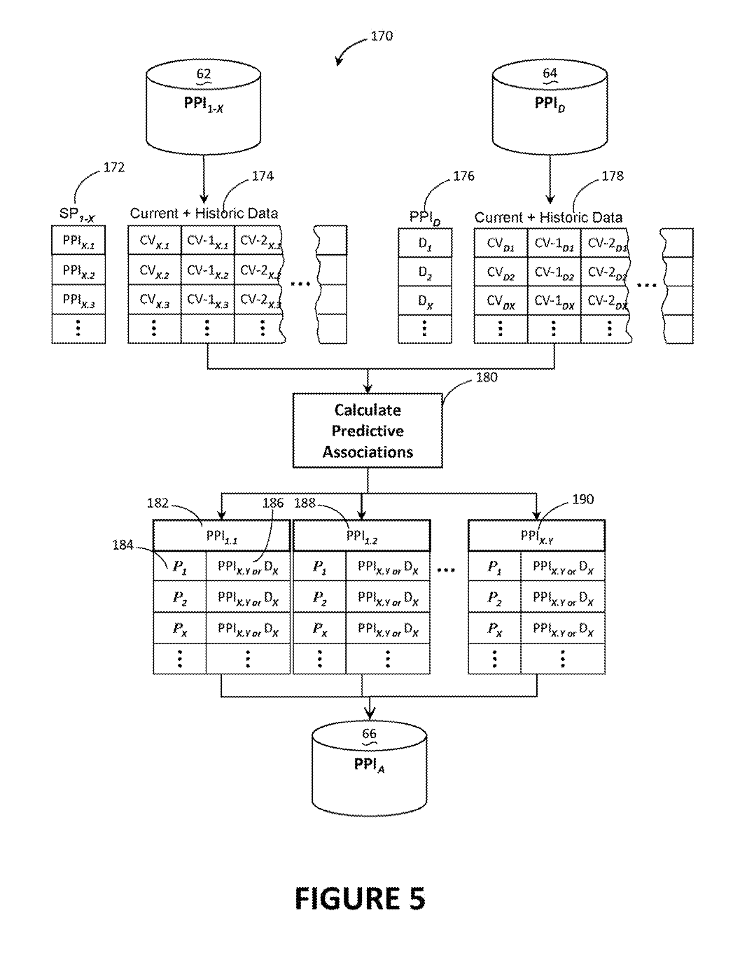

When referencing a subject property to a property price index, the CPRS system 12 permits users to use a property price index provided by a service provider for the subject property's statistical geographic subdivision or the user may use an alternative or derivative property price index. The ability to use an alternative or derivative property price index is determined by the association between primary property price index and the derivative property price index. For example, the user may have a subject property with limited, or lesser known, property price indices. The user may wish to substitute the subject property's primary property price index with a better known index, e.g. Case-Shiller. Based on how the primary property index is associated with the Case-Shiller property price index, or combination of indices, the users may prefer to reference the subject property to the alternative, or derivative index. FIG. 5 is a flowchart that illustrates one example of how associations between the property price indices 170 are created. The CPRS system 12 stores all of the property price indices values in database 62 and the derivative property price indices in database 64. The system retrieves the records for each property price index 172. A table is created with the current and historic levels 174 of the property price index. The system then retrieves the records for all derivative property price indices from all service providers 176. An additional table is created with the current and historic levels for all derivative property price indices 178 for all property price indices. The system then calculates the associations between property price indices and derivative property price indices using proprietary algorithms 180. A table for each property price index 182 is then created ranking alternative and derivative property price indices. The ranking is determined by the CPRS system 12 generated probability 184 that the alternative or derivative property price index 186 will be highly correlated with the property price index over the term of a CPRS. Association are calculated for each service provider's property price indices 186 and for all the service providers property price indices 190. The associated price indices records are then stored in the associated property price index database 66.

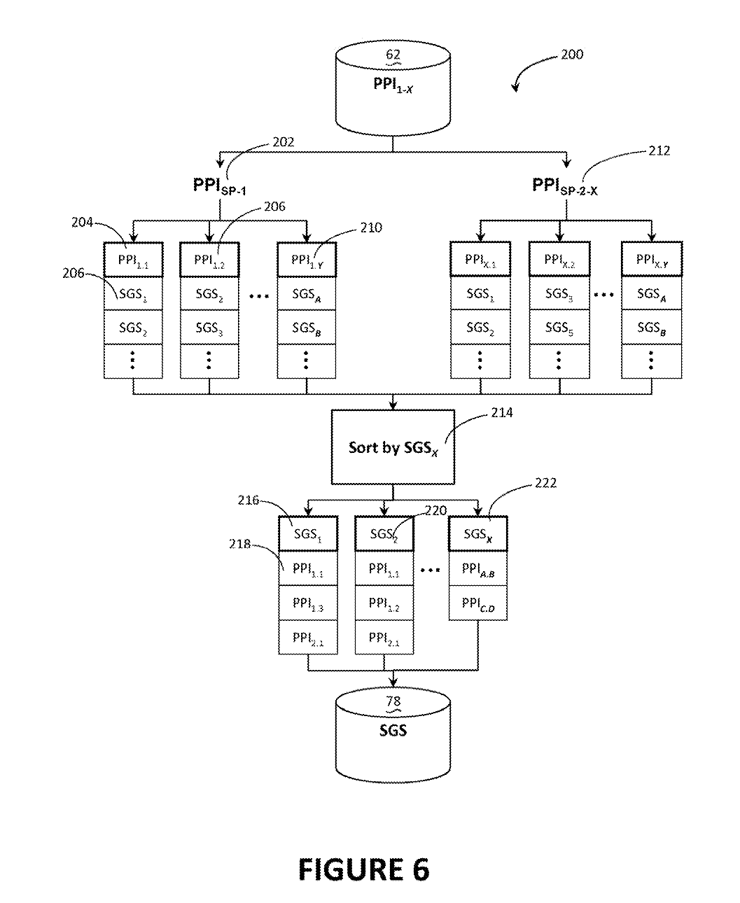

FIG. 6 is a flow chart illustrating one methodology for identifying which property price indices are related with which statistical geographic subdivisions 200. The CPRS system 12 stores all the property price indices in database 62. The system retrieves the records for property price indices from a service provider 202. A table is created for one of the service provider's property price indices 204 listing the statistical geographic subdivisions that are used in calculating the index 206. An additional table is created for the next property price index 206 and all of the property price indices for that service provider 210. Similar tables are created for all of the service providers and their corresponding property price indices 212. The CPRS system 12 sorts the tables by statistical geographic subdivisions 214. A table is created for the first statistical geographic subdivision 216 which lists all of the property price indices that use it in the calculation of their index 218. An additional table is created for the next statistical geographical subdivision 220 and for all the statistical geographic subdivisions 222. The records are stored in the statistical geographic subdivision database 78.

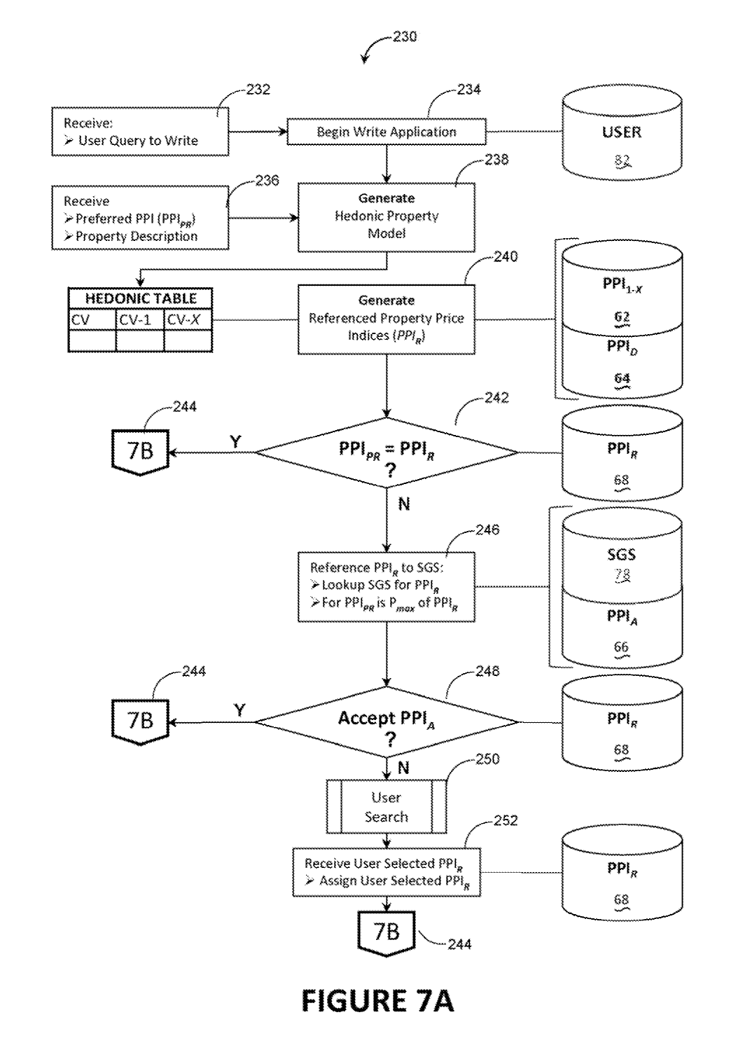

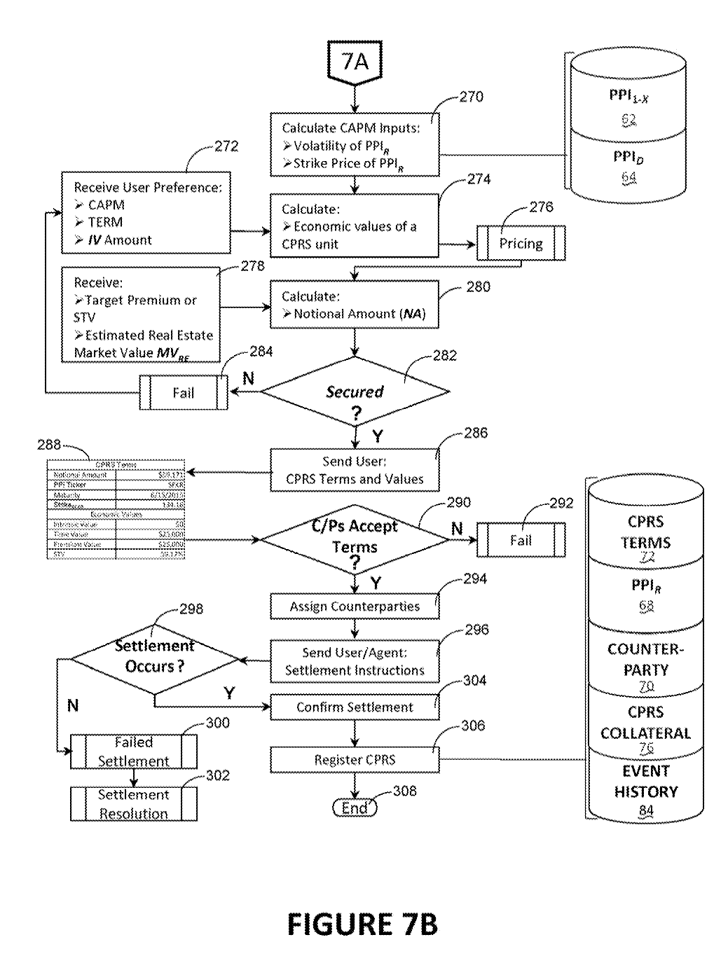

FIG. 7A is a flowchart illustrating the process for writing CPRS units on a subject property 230. Writing CPRS units can be performed on a standalone basis or in conjunction with a loan origination, loan modification or a property sale. In step 232 the user logs into the CPRS system and submits a query to write CPRS. In step 234 the system begins the writing application by retrieving the user information from the user database 82. In step 236 the system receives the user's preferred property price index and the property's description. In step 238 the system generates a hedonic property valuation model. In step 240 the system generates a referenced property price index by comparing the subject property's hedonic model to the systems database of property price indices 62 and derivative property price indices 64. In step 242 a determination is made if the preferred property price index can be used as the referenced property price index. If it can, the system updates the referenced property price index database 68 and the writing application continues 244, if it cannot the system moves to step 246 to search the statistical geographic subdivisions 78 and associated property price index 66 to identify the associated property price index with both the highest probability of correlating to the hedonic property model and contains a component(s) of the preferred property price index. In step 248 a determination is made if the user can accept the associated property price index selected by the system as the referenced index for the subject property. If the user can, the system updates the referenced property price index database 68 and the writing application continues 244, if the user cannot the system moves to step 250 where the user is given the option to search the associated property price index to manually select an associated property price index to reference to the subject property. The user searches the system to identify the property price index or derivative property price index they would like used as the referenced property price index. In step 252 the user selected associated property price index is received by the system, the system references the selected associated property price index to the subject property, updates the referenced property price index database 68 and the writing application continues 244. In all cases, once the subject property is referenced to a property price index, or an associated property price index, the values of the index will be used in calculating the economic values of the CPRS units.

FIG. 7B is a flow chart illustrating a method for the CPRS system 12 to calculate the CPRS units terms. In step 270 the system calculates the volatility and the “at-the-money” strike price of the references property price index to be used in pricing the CPRS by retrieving the corresponding records from the property price index database 62 and the derivative property price index database 64. In step 272 the system receives the user preferences for capital asset pricing model (CAPM) to use in calculating the time value, the term (expiration date) and the target intrinsic value. In step 274 the system calculates the economic values for a single CPRS unit by using the pricing application in step 276. In step 278 the system receives the user preferences for either the target premium or the maximum Structure to Value ratio (STV) and the user's estimate of the subject property's current market value. In step 280, the system calculates the notional amount of the CPRS units and in step 282 a determination is made whether the CPRS is fully secured. If the CPRS is not fully secured in step 284 the system provides the user with multiple option to write a CPRS which is either fully secured or the maximum number of CPRS units have been issued for the subject property. If yes, in step 286 the system sends the user the terms and the economic values of the CPRS for the counterparties review. The terms include; the notional amount, the referenced property price index, the expiration date, the call or put structure identifier and the referenced property price index strike price. The economic values include; the intrinsic value, the time value, the premium value and the STV. In step 290 a determination is made whether the counterparties (the CPRS writer and the CPRS holder) accept the terms of the CPRS units. If not, the application goes to step 292 where the system generates a failed status and the application ends. If the counterparties accept the terms the system goes to step 294 and assigns the CPRS units to the respective counterparty. In step 296 the system sends settlement instructions to the user and/or the user's settlement agent. In step 298 a determination is made whether settlement occurs on the agreed upon settlement date. If not, in step 300 the system generates a failed settlement status. In step 302 the system is provided the necessary information from the user to resolve the failed status, such as a new settlement date or canceled CPRS. If settlement occurs, in step 304 the system receives confirmation of the settlement. In step 306 the system registers the CPRS units to the respective counterparties and updates the CPRS Terms database 72, the referenced property price index database 68 the counterparty database 70 the CPRS collateral database 76 and the event history database 84. In step 308 the writing application ends.

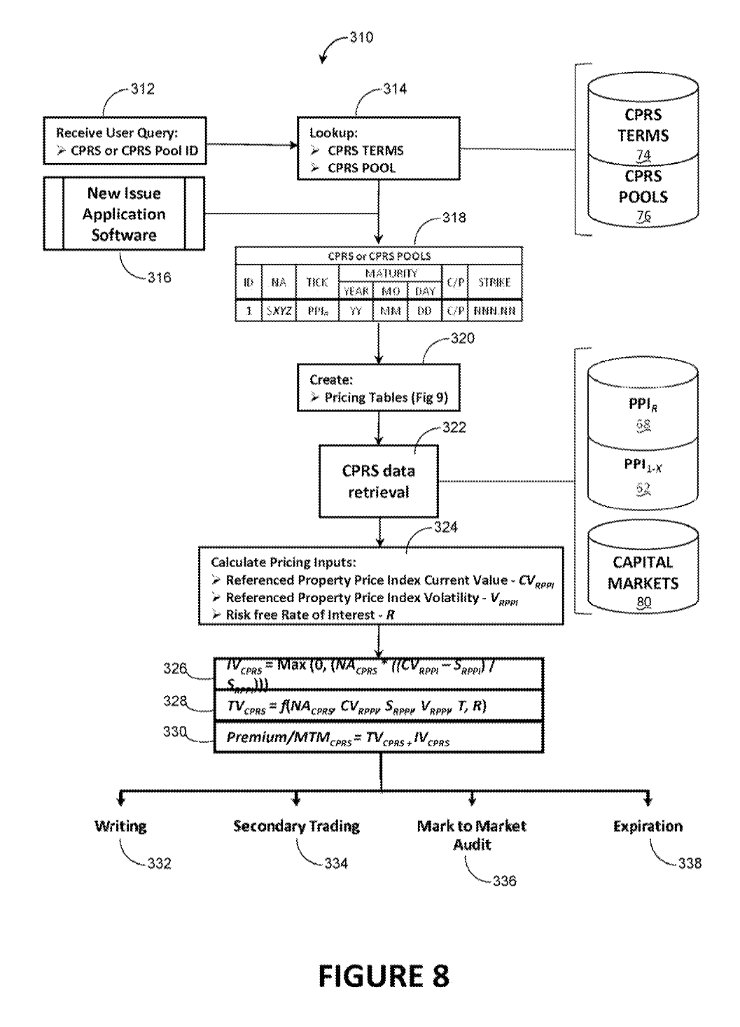

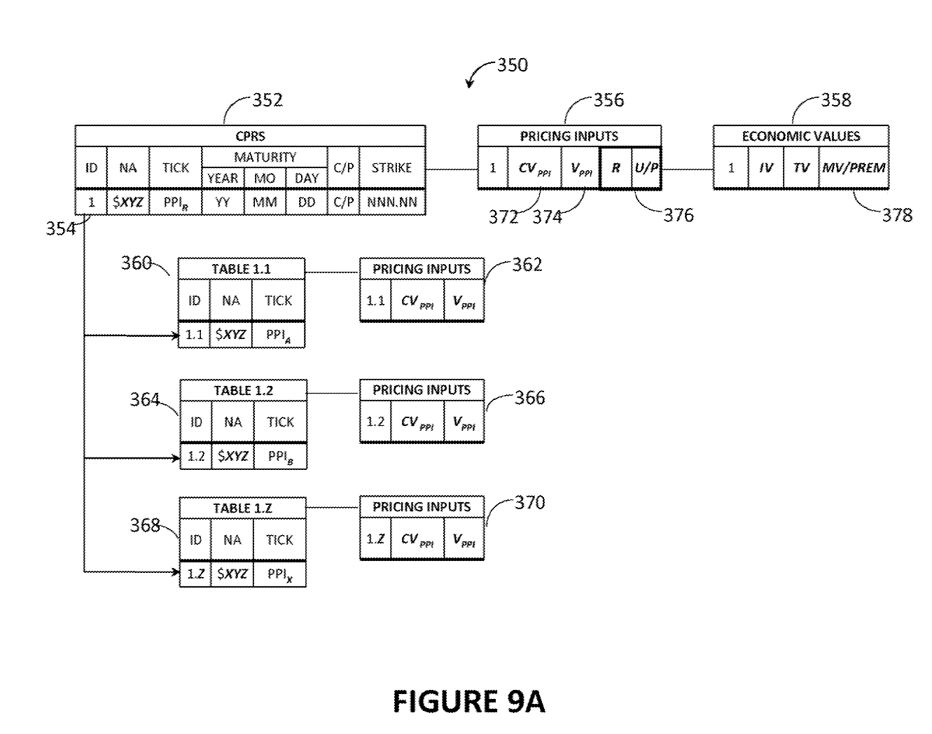

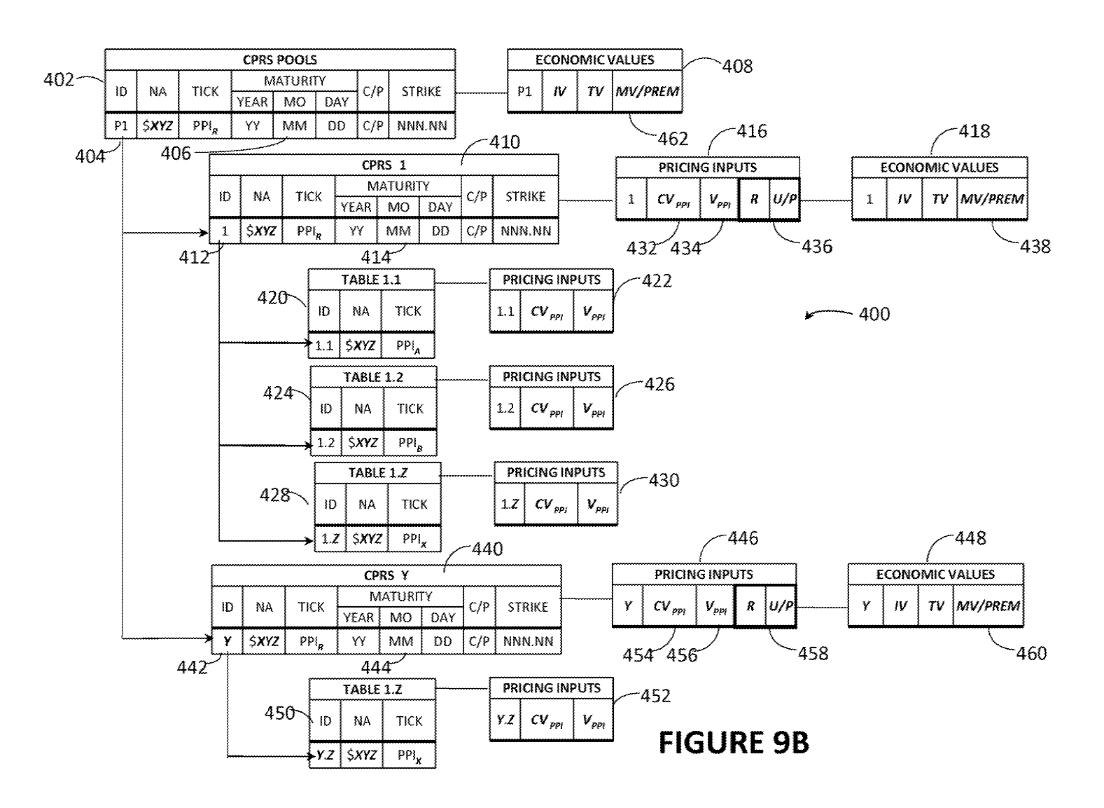

FIG. 8 is a flow chart illustrating the pricing process used to determine the intrinsic value, time value and premium or market value of CPRS units and CPRS pools 310. In step 312 the system receives a query from a user looking for pricing CPRS units or CPRS pools. In step 314 the system retrieves the required data to price from the CPRS Terms database 72 or the CPRS Pools database 74 based on the unique security identifier. In step 316, queries to price may also come from the Writing Application 34. When the pricing query originates from the Writing Application 34, the terms for the CPRS units are provided by the application rather than retrieved from the database. In step 318 the system generates the primary term table which includes; the notional amount, the referenced property price index identifier, the expiration (maturity) date, the call or put designation and the referenced property price index strike number. In step 320 the system generates the pricing tables to be used in calculating the economic values (see FIG. 9). In step 322, the system retrieves the required data to calculate various pricing factors from the referenced property price index database 68, the property price index database 62 and the capital markets database 80. Using this data, in step 324 the system calculates the referenced property price index's current value, the referenced property price index's volatility and the risk free rate of interest. Other pricing inputs may be calculated at this time based on the capital asset pricing model being used by the system. However, the theoretical estimated market value of the subject property is not used in calculating the intrinsic value, the time value or the premium value of the CPRS units or CPRS pools. Also, the data used to calculate pricing inputs such as the volatility and the current value of the referenced property price index are provided by independent third parties which can be verified by the user, counterparty, potential investors, auditors and others. In step 326, the system calculates the intrinsic value of the CPRS units or CPRS pools. The intrinsic value is also known as the amount that the option is “in-the-money”. The intrinsic value is based on the change in the referenced price index. The intrinsic value is the amount due if expiration (maturity) was today and is never less than zero. In step 328 the system calculates the time value. Calculating the time value uses the following factors; the notional amount, the current value of the referenced property price index, the strike price of the referenced property price index, the volatility of the referenced property price index, time to expiration (maturity), the call/put indicator and the risk free rate of interest. There may be other factors used in calculating the time value depending on the pricing model, but the theoretical estimated market value of the subject property is not a factor in calculating the time value. In step 330 the system calculates the premium value or the theoretical market value of the CPRS units or CPRS pool. This value is the sum of the intrinsic value and the time value. In step 332 the Pricing Application 32 is used during Writing of CPRS units. In Step 334 the Pricing Application 32 is used for the secondary trading of CPRS units and CPRS pools. In step 336 the Pricing Application 32 is used in marking-to-market CPRS units and CPRS pools. Marking-to-market queries may occur during periodic audits of a CPRS position. In step 338 the Pricing Application 32 is used when the CPRS units' term expires (matures).

FIG. 9A illustrates one embodiment of how the system creates tables from CPRS units for pricing purposes 350. In step 352 the system has generate the terms table for a CPRS. In step 354, the CPRS identification code is used as a unique identifier for this CPRS. Each CPRS written has a unique identification code. In step 356 the system sets up the table for the pricing inputs and in step 358 the system sets up the table for the economic values. In step 360 the system sets up the first CPRS component table. CPRS units may be made up of multiple components based on the structure of the referenced property price index. If the CPRS referenced property price index is comprised of one hundred percent of a single property price index then pricing will only require one component table. If the referenced property price index is comprised of multiple property price indices a CPRS component table will be created for each property price index used in calculating the referenced property price index. The component table terms are; the components appended identification code, the notional amount of the component and the property price index of the component. The system allocates the terms of component table 1 based on the composition of the corresponding property price index. For example, if fifty percent of the referenced property price index of the CPRS is property price index A, fifty percent of the notional amount of the CPRS will be allocated to the property price index A's component table. In step 362 the system sets up the pricing input table and calculates the current value of the property price index and the volatility of the property price index used in component table 1. In step 364, the system sets up the second component table, if necessary and allocates the terms for table two based on the property price index and its proportions within the referenced property price index's composition. In step 366 the system sets up the pricing input table and calculates the current value of the property price index and the volatility of the property price index used in component table 2. Step 368 illustrates how the system will create as many component tables as required for pricing a CPRS. The system allocates the terms for all the remaining component tables based on the property price indices and their respective proportions within each component table's referenced property price index's composition. In step 370 the system sets up the pricing input table and calculates the current value for each property price index and the volatility for each property price index used in each of the subsequent component tables. In step 372 the system aggregates the current value for all the CPRS components property price indices and calculates the current value of the referenced property price index for the CPRS. In step 374 the system aggregates the volatility for all the CPRS component property price indices and calculates the volatility of the referenced property price index for the CPRS. In Step 376 the system inputs the risk free interest rate, R, and other inputs based on user preferences, U/P. In step 378 the system calculates the economic values of the CPRS including; intrinsic value, time value and market value or premium value.

FIG. 9B illustrates one embodiment of how the system creates tables from CPRS Pools for pricing purposes 400. In step 402 the system has generate the terms table for a CPRS Pool. In step 404, the CPRS Pool identification code is used as the unique identifier for this CPRS Pool to retrieve the terms from the database. Each CPRS pool has a unique identification code. In step 406 the system generates the terms of the pool including; notional amount, the referenced property price indices ticker, the final expiration date, the call/put identifier and the referenced property price index strike price. In step 408 the system sets up the table for the economic values of the pool. In step 410 the system generates the terms table for the first CPRS in the pool. In step 412, the CPRS identification code is used as a unique identifier for this CPRS to retrieve the terms from the system. Each CPRS written has a unique identification code. In step 414 the system generates the terms of the first CPRS including; notional amount, the referenced property price indices ticker, the final expiration date, the call/put identifier and the referenced property price index strike price. In step 416 the system sets up the table for the pricing inputs and in step 418 the system sets up the table for the economic values. In step 420 the system sets up the first CPRS component table. CPRS units may be made up of multiple components based on the structure of the referenced property price index. If the CPRS referenced property price index is comprised of one hundred percent of a single property price index then pricing will only require one component table. If the referenced property price index is comprised of multiple property price indices a CPRS component table will be created for each property price index used in calculating the referenced property price index. The component table terms are; the components appended identification code, the notional amount of the component and the property price index of the component. The system allocates the terms of component table 1 based on the composition of the corresponding property price index. For example, if fifty percent of the referenced property price index of the CPRS is property price index A, fifty percent of the notional amount of the CPRS will be allocated to the property price index A's component table. In step 422 the system sets up the pricing input table and calculates the current value of the property price index and the volatility of the property price index used in component table 1. In step 424, the system sets up the second component table, if necessary, and allocates the terms for table two based on the property price index and its proportions within the referenced property price index's composition. In step 426 the system sets up the pricing input table and calculates the current value of the property price index and the volatility of the property price index used in component table 2. Step 428 illustrates how the system will create as many component tables as required for pricing this CPRS. The system allocates the terms for all the remaining component tables based on the property price indices and their respective proportions within each component table's referenced property price index's composition. In step 430 the system sets up the pricing input table and calculates the current value for each property price index and the volatility for each property price index used in each of the subsequent component tables. In step 432 the system aggregates the current value for all the CPRS components property price indices and calculates the current value of the referenced property price index for this CPRS. In step 434 the system aggregates the volatility for all the CPRS component property price indices and calculates the volatility of the referenced property price index for the CPRS. In Step 436 the system inputs the risk free interest rate, R, and other inputs based on user preferences, U/P. In step 438 the system calculates the economic values of the first CPRS including; intrinsic value, time value and market value or premium value.

Step 440 illustrates how the system will create as many CPRS terms table as required for pricing the CPRS pool. In step 442, the CPRS identification code is used as a unique identifier for this CPRS to retrieve the terms from the system. In step 444 the system generates the terms for each remaining CPRS in the pool. In step 446 the system sets up the table for the pricing inputs and in step 448 the system sets up the table for the economic values for each remaining CPRS. In step 450 the system sets up the remaining CPRS component table(s). In step 452 the system sets up the pricing input table and calculates the current value of the property price index and the volatility of the property price index used in each remaining component table. In step 454 the system aggregates the volatility for all the remaining CPRS and CPRS component property price indices and calculates the volatility of the referenced property price index for the CPRS. In Step 456 the system inputs the risk free interest rate, R, and in step 458 the system inputs other pricing factors based on user preferences, U/P. In step 460 the system calculates the economic values of the remaining CPRS including; intrinsic value, time value and market value or premium value.

In step 462 the system aggregates the economic values of all the CPRS units in the pool including; intrinsic value, time value and market value or premium value.

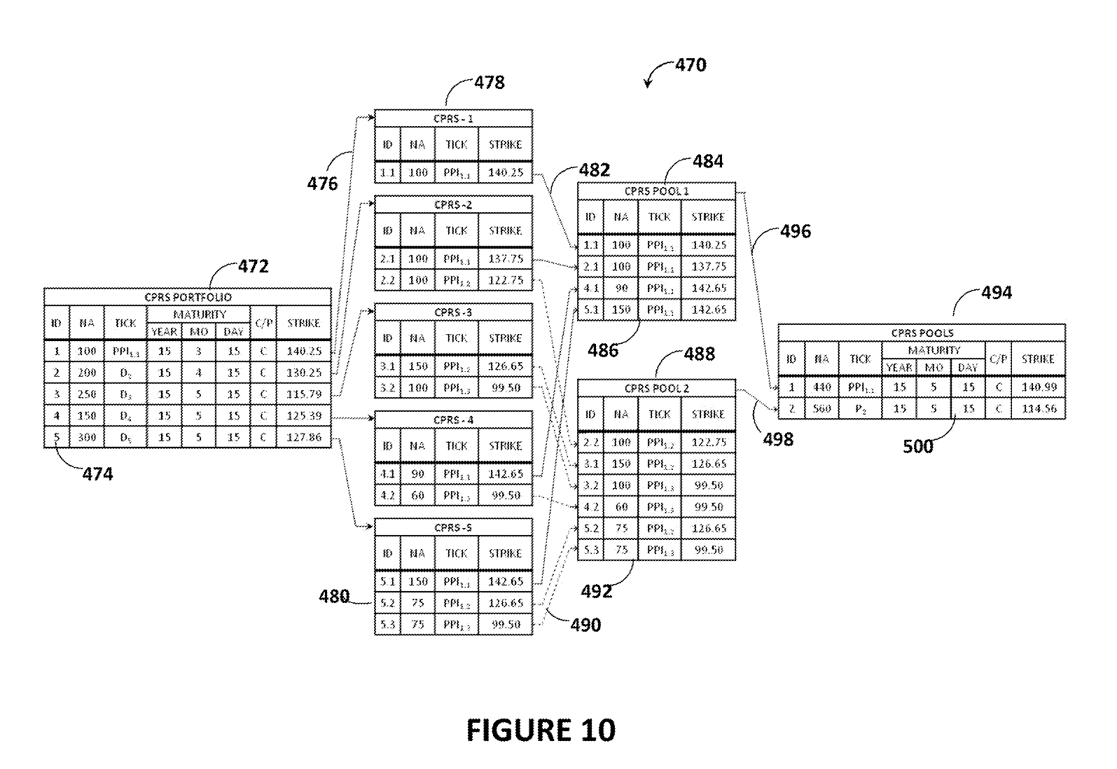

FIG. 10 illustrates one embodiment how the system pools a portfolio of CPRS units, step 470. In step 472 the system receives a portfolio of CPRS units. In Step 474 the system lists each CPRS unit within the portfolio by their corresponding unique identification numbers and lists the terms for each CPRS including; the notional amount, the referenced property price index ticker, the expiration date, the call/put identifier and the referenced property price index strike price. In step 476 the system segregates the first CPRS unit in the portfolio into a pooling table and in step 478 the system identifies the terms for the first CPRS unit, including all of the unit's component parts. CPRS units may be made up of multiple components based on the structure of the referenced property price index. If the CPRS referenced property price index is comprised of one hundred percent of a single property price index then the pooling table will only require terms for one component. If the referenced property price index is comprised of multiple property price indices a CPRS pooling table will create terms for each property price index used in calculating the referenced property price index. The pooling table component terms are; the components appended identification code, the notional amount of the component, the property price index of the component, the call/put identifier and the referenced property price index strike price. The system allocates the terms of component tables based on the composition of the corresponding property price index. For example, if fifty percent of the referenced property price index of the CPRS is property price index A, fifty percent of the notional amount of the CPRS will be allocated to the property price index A's component table. In step 480 the system has generated tables for all of the CPRS units and their corresponding components within the portfolio to be pooled.

In step 482 the system allocates the first component of the first CPRS unit into CPRS pool 1. In step 484, the system allocates all of the remaining components of each CPRS into CPRS pool 1. The user may specify pools to be formed using a number of filters for CPRS units and CPRS components including; referenced property price indices, property price indices, expiration date, statistical geographic subdivision, intrinsic value and others. The user may also form pools generically with no consideration to specified filters. In step 486 the system aggregates all the CPRS components for the user's filter, property price index 1.1, into pool one.

In step 488 the system sets up CPRS pool 2 to receive the remaining CPRS components. In step 490 the system allocates all the remaining CPRS components into pool number 2. In step 492 the system aggregates all the CPRS components for a generic property price index pool. In step 494 the system generates the CPRS pool terms table. In step 496 the CPRS pool one is formed and the terms are aggregated into the CPRS pool terms table. The terms include; the pool's unique identification number, the notional amount of the pool, the pool referenced property price index ticker, the final expiration date of the pool, the call/put identifier and the pool's referenced property price index strike price. In pool one, the pool's referenced property price index ticker is the ticker for property price index 1.1. In step 498 the CPRS pool two is formed and the terms are aggregated into the CPRS pool terms table. In pool two, the pool's referenced property price index ticker is unique to the pool as the pool's referenced property price index is made up of a number of property price indices and derivative property price indices. In step 500 the system updates the CPRS Pool database with the terms of the two new pools.

Various methods and apparatus have been described. The present invention is not to be limited to the specific embodiments provided here. The present invention contemplates numerous variations and alternatives. For example, the present invention contemplates variations in the manner in which a reference property price index is created, the manner in which the value or a CPRS or CPRS pool is calculated, and other variations. The present invention contemplates variations in the computing devices used in performing various steps of the methods, the manner in which data is stored or organized on computer readable storage media, the manner in which data is communicated across a network, the manner in which software, software components, or databases are stored in computer readable storage media and other variations, options, and alternatives.

What is claimed is:

1. An automated method for creating a reference property price index to be used as an alternative to an estimated market value of individual real estate parcels for use in writing real estate options secured by individual real estate parcels, the automated method comprising:
creating a configuration library and site hierarchy repository for storing data pertaining to (a) statistical geographic subdivisions (SGS), (b) property price indices (PPI_{1-X}), (c) derivative property price indices (PPI_{D}), (d) associated property price indices (PPI_{A}), and (e) referenced property price indices (PPI_{R});
electronically receiving over a computer network from a plurality of service providers user-independent information pertaining to a plurality of (a) statistical geographic subdivisions (SGS) and (b) property price indices (PPI_{1-X});
accessing application software configured to administer controlling logic and conventions for calculating a reference property price index;
electronically processing the data to create relational databases for (a) derivative property price indices (PPI_{D}), (b) associated property price indices (PPI_{A}), and (c) referenced property price indices (PPI_{R});
electronically storing in a computer readable storage format the (a) statistical geographic subdivisions (SGS), (b) property price indices (PPI_{1-X}), (c) derivative property price indices (PPI_{D}), (d) associated property price indices (PPI_{A}), and (e) referenced property price indices (PPI_{R}).

2. The method of claim 1 wherein the statistical geographic subdivisions comprise data for a plurality of (a) metropolitan statistical areas, (b) postal codes, (c) census tracks and (d) other subdivisions.

3. The method of claim 1 wherein the property price indices comprise indices for a plurality of (a) regions, (b) metropolitan statistical areas and (c) other statistical subdivisions.

4. The method of claim 1 wherein the property price indices comprise (a) historic values and (b) current values.

5. The method of claim 1 wherein the property price indices being derived from methodologies based on including (a) average sale price, (b) repeat sale prices, or (c) hedonic pricing models.

6. The method of claim 1 wherein the step of receiving property price indices further comprises receiving geographic identifiers of the areas that comprise each index.

7. The method of claim 1 wherein the step of creating a relational database of derivative property price indices further comprises defining theoretical property price indices composed of (a) a plurality of property price indices, (b) a plurality of mathematically modified property price indices, (c) a plurality of property price indices combined with a plurality of mathematically modified property price indices or (d) any combination thereof.

8. The method of claim 7 wherein composition of a derivative property price index may change over time.

9. The method of claim 7 wherein derivative property price indices includes theoretical values for each derivative index, including (a) current values and (b) historic values.

10. The method of claim 9 wherein the current and historical values are calculated by (a) calculating the correspondent values for each of the derivative property price index components and (b) aggregating all of the component values into a single corresponding current or historical value.

11. The method of claim 1 wherein the step of creating a relational database comprises calculating associations between (a) property price indices to other property price indices (PPI_{X}:PPI_{Y})and (b) property price indices to derivative property price indices (PPI_{X}:PPI_{DY}).

12. The method of claim 11 wherein the step of calculating statistical associations between the plurality of property price indices and derivative property price indices further comprises of defining a source table having a plurality of rows that represent the plurality of indices and a plurality of columns that represent the plurality of time periods, each row-column position is measured against its next row-column position to calculate a plurality of measurements of change in each index over time and measurements are compared against the other indices to identify patterns of change such that probabilities that analogous adjustments are likely to occur between indices over future periods of time and then records the predicted association between indices.

13. The method of claim 1 wherein the step of creating a relational database of referenced property price indices further comprises joining the statistical geographic subdivisions with matching property price index and derivative property price indices creating a plurality of tables having rows that represent the statistical geographical subdivisions and the columns represent property price indices and derivative property price indices.

14. The method of claim 13 wherein the step of creating referenced property price indices further includes associated property price indices are (a) ranked by the calculated predictive association from most likely to least likely for each SGS within the database (b) filtered to remove low probability associated property price indices.

15. The method of claim 13 wherein every statistical geographic subdivision is referenced to a minimum of one property price index or derivative property price index.

16. The method of claim 13 wherein referenced relationships change over time.

17. A computer implemented method for calculating time value, intrinsic value and theoretical market value of a CPRS or a CPRS pool, the method comprising the steps of:
creating a configuration library and site hierarchy repository for (a) a plurality of derivative capital asset pricing models and (b) capital markets data;
electronically receiving over a computer network, from a plurality users: (a) valuation requests and (b) user's preferred capital asset valuation model and (c) CPRS or CPRS pool descriptions;
electronically receiving over a computer network, from a plurality of service providers data comprising user-independent information related to capital markets, (a) interest rates and (b) user defined capital asset pricing model inputs;
electronically retrieving from database records of a system (a) CPRS terms or CPRS pool terms and (b) property price indices (PPI_{1-X});
accessing controlling logic of the system which administers conventions for valuing CPRSs;
processing the data using a computing device to calculate (a) valuation model inputs, (b) or time value, (c) the intrinsic value and (d) the theoretical market value;
electronically generating reports and transmitting said reports over a computer network, in a predefined format, to a plurality of users; information related to CPRS values including (a) counterparty descriptions, (b) the CPRS terms or CPRS pool terms, (c) a description for the referenced property price index(s), (d) the time value, (e) the intrinsic value and (f) the theoretical market value.

18. The method of claim 17 wherein CPRS or CPRS pool include (a) identification codes, (b) appended identification codes and (c) pool codes.

19. The method of claim 17 wherein CPRS terms include (a) a notional amount (b) a referenced associated property price index, (c) an expiration date and (d) a strike price.

20. The method of claim 17 wherein property price indices (PPI_{1-X}) further comprise (a) historic values and (b) current values.

21. The method of claim 17 wherein a convention for calculating the time value and the intrinsic value of CPRSs is to use this method for (a) writing, (b) trading, (c) auditing and (d) search inquiries.

22. The method of claim 17 wherein the step of processing the data to calculate the valuation model inputs further includes the steps of calculating volatility of the referenced property price index (PPI_{R}).

23. The method of claim 17 wherein processing the data to calculate the time value is further defined as a function of:
TV_{CPRS}=f(NA_{CPRS}, CV_{PPIR}, S_{PPIR}, V_{PPIR}, T, R),
wherein (a) TV_{CPS}—the time value of the CPRS, (b) NA_{CPRS}—the notional amount of the CPRS, (c) CV_{PPIR}—the current value of the referenced property price index(PPI_{R}), (d) S_{PPIR}—the strike price of the referenced property price index (PPI_{R}), (f) V_{PPIR}—the volatility of the referenced property price index (PPI_{R}), (g) T—the time to expiration and (h) R—the risk-free rate of interest.

24. The method of claim 17 wherein processing the data to calculate the intrinsic value is further defined as a function of:
IV_{CPRS}=Maximum(0, (NA_{CPRS}*((CV_{PPIR}−S_{PPIR})/S_{PPIR}))),
wherein (a) IV_{CPRS}—the intrinsic value of the CPRS, (b) NA_{CPRS}—the notional amount of the CPRS, (c) CV_{PPIR}—the current value of the referenced property price index (PPI_{R}) and (d) S_{PPIR}—the strike price of the referenced property price index (PPI_{R}).

25. The method of claim 22 further comprise generating source tables which allocate component parts of the CPRS or CPRS pool into pre-defined tables.

26. The method of claim 25 further comprising allocating the notional amount of the CPRS or CPRS pool proportionally for each component within each table.

27. The method of claims 25 further comprising aggregating into a single table the pricing inputs for the CPRS units including (a) current value of the referenced property price index and (b) the volatility of the referenced property price index.

28. The method of claim 17 wherein processing the data to calculate the theoretical market value is further defined as:
MV_{CPRS}=TV_{CPRS}+IV_{CPRS},
wherein (a) MV_{CPRS}—the theoretical market value of the CPRS, (b) TV_{CPRS}—the time value of the CPRS and (c) IV_{CPRS}—the intrinsic value of the CPRS.

29. A computer implemented method for writing a Call Put Referenced Structure (CPRS), the method comprising steps of:
creating a configuration library and site hierarchy repository for storing data pertaining to (a) user information, (b) counterparty information, (c) collateral description (d) CPRS terms and (e) CPRS history;
electronically receiving over a computer network, from a plurality of users, (a) queries regarding issuance of CPRS, (b) information related to user preferences and (c) descriptive information of collateral;
electronically retrieving from database records of a system, the database record comprised of user-independent information pertaining to (a) property price indices (PPI_{1-X}), (b) derivative property price indices (PPI_{D}) and (c) referenced property price indices (PPI_{R});
accessing controlling logic of the system which administers the writing the CPRS including conventions that (a) the referenced property price index is a substitute for real estate market value, (b) CPRS may be a call or put option and (c) CPRS can be secured by real estate and issued as a mortgage;
processing the data using a computing device to (a) create a hedonic model for the subject property, (b) reference a subject property parcel to an associated property price index, (c) calculate a new issue CPRS economic values and (d) calculate a new issue CPRS terms;
electronically generating reports and transmitting the reports over a computer network, in a predefined format, to a plurality of users, information related to CPRS including (a) counterparty descriptions, (b) the CPRS terms, (c) the referenced property price index(s) description, (d) the CPRS economic values and (e) settlement instructions;
assigning the CPRS to matched counterparties, one counterparty wishing to write an instrument and the other counterparty wishing to purchase the instrument in response to (a) both counterparties accepting the terms and (b) the seller accepting the buyer's price, or the buyer accepting the seller's price;
electronically generating and transmitting reports over the computer network to a plurality of user settlement agents, in a predefined format, information related to CPRS new issue settlement instructions including (a) the counterparties, (b) the CPRS terms, (c) new issue economic values, (d) settlement timing, and (e) the CPRS's unique identification code;
electronically receiving from a plurality of user agents settlement confirmation and automatically (a) registering the CPRS for each counterparty and (b) updating the database records, if the settlement was performed.

30. The method of claim 29 wherein the user preferences includes preferences associated with (a) property price indices, (b) expiration date, (c) time valuation methodology, (d) target terms and (e) currency.

31. The method of claim 30 wherein the user preferences include (a) target premium amount or (b) target structure to value ratio (STV).

32. The method of claim 30 wherein the user preferences include a target strike price factor to be either (a) in the money, (b) at the money or (c) out of the money.

33. The method of claim 29 wherein the conventions of the CPRS further provide that a CPRS may be written between two counterparties (a) on a negotiated basis or (b) through an exchange or (c) over the counter using a brokerage house or (d) using another suitable service provider that can facilitate the issuance (underwriting) of the transaction.

34. The method of claim 29 wherein the conventions of the CPRS further provide that a CPRS which is secured by real estate may be issued in the form of a mortgage.

35. The method of claim 35 wherein the conventions of the CPRS further provide that a CPRS written in the form of a mortgage may be describe within the terms of the mortgage as (a) an option (call or put) or (b) a method of calculating the principal and/or interest due at maturity.

36. The method of claim 35 wherein the conventions of the CPRS further provide that a CPRS may be written (a) as a single mortgage transaction, (b) in conjunction with a mortgage debt underwriting (c) in conjunction with a mortgage debt refinancing and (d) in conjunction with a mortgage debt modification.

37. The method of claim 35 wherein the CPRS is secured by real estate and the method further comprising (a) collecting the subject property data to be used in creating a hedonic pricing model and (b) estimated current market value of the real estate.

38. The method of claim 29 wherein the conventions of the CPRS further provide that a CPRS may be written in conjunction with (a) a voluntary real estate sale, (b) a short sale, (c) a foreclosure sale, (d) a Real Estate Owned (REO) sale and (e) any other exchange of real estate where there is economic compensation between the real estate buyer and seller.

39. The method of claim 29 wherein processing the data to reference the subject property parcel to an associated property price index is determined by the (a) subject property hedonic model and (b) user preferences.

40. The method of claim 29 wherein processing the data to calculate the CPRS economic values is performed by using property price indices.

41. The method of claim 40 wherein calculating the CPRS economic values further includes the steps of (a) calculating the economic values of a single CPRS unit of the preferred currency and (b) recalculating the economic values based on the user preferences.

42. The method of claim 29 wherein processing the data to calculate the CPRS terms further includes the steps of calculating (a) a notional amount, (b) a referenced property price index strike price and (c) either a CPRS premium amount or a structure to value ratio.

43. The method of claim 42 wherein processing the data to calculate the notional amount further includes the steps of (a) if the user's preference is for a target premium amount, the notional amount is calculated by:
NA_{CPRS}=TP/MV_{1CPRS}
or (b) if the user preference of for a target structure to value ratios, the notional amount is calculated by:
NA_{CPRS}=MV_{RE}*STV_{T}
where: (a) NA_{CPRS}—the notional amount of the CPRS (b) TP—the user's target premium, (c) MV_{1CPRS}—the theoretical market value of a single CPRS, (d) MV_{RE}—the estimated market value of the real estate collateral and (e) STV_{T}—the user's target structure to value ratio.

44. The method of claim 42 wherein processing the data to calculate the strike price further includes the step of multiplying the current value referenced property price index by a user's strike price factor.

45. The method of claim 42 wherein processing the data to calculate either the CPRS premium or the structure to value ratio further includes the steps of (a) if the user preference is to target the structure to value ratio, the premium is calculated using:
P_{CPRS}=NA_{CPRS}*MV_{1CPRS}
or (b) if the user preference is to target the premium, the structure to value ratio is calculated by:
STV_{CPRS}=NA_{CPRS}/MV_{RE}
where: (a) P_{CPRS}—premium value of the CPRS, (b) NA_{CPRS}—the notional amount of the CPRS, (c) MV_{1CPRS}—the theoretical market value of a single CPRS, (d) STV_{CPRS}—structure to value ratio (expressed as a percentage), (e) NA_{CPRS}—the notional amount of the CPRS and (f) MV_{RE}—the current market value of the subject real estate property.

46. The method of claim 45 wherein calculating the structure to value ratio further comprises the steps of determining if the CPRS is fully secured for (a) a newly written CRPS and (b) all outstanding CPRS where the subject property is used as collateral.

47. The method of claim 29 wherein the steps of generating a report and transmitting the CPRS terms further comprises automatically assigning the CPRS's unique identification codes including (a) a unique identifier for the CPRS and (b) appending the CPRS identification code with additional identification codes for each component part of the referenced property price index.

48. A computer implemented method for pooling Call-Put Referenced Structures (CPRS) the method comprising steps of:
creating a configuration library and site hierarchy repository for storing data pertaining to CPRS pools;
electronically receiving over a computer network, from a plurality users, user's requests and preference related to pooling CPRSs and existing pools including (a) user filters to form pools and (b) CPRS identification codes;
accessing controlling logic of a system which administers the conventions for pooling including (a) user pooling rights and (b) terms permitted in a single pool;
electronically retrieving from database records of the system, the database records of outstanding Call-Put Referenced Structures to be aggregated comprising information related to (a) CPRS terms, (b) CPRS components, (c) CPRS pools, (d) CPRS collateral, (e) CPRS counterparties, (f) CPRS users, (g) statistical geographic subdivision, (h) property price indices, (i) derivative property price indices, (j) associated property price indices, (k) reference property price indices, (l) CPRS history and (m) other administrative records;
processing the information using a computing device to (a) create source tables for each CPRS and CPRS component, (b) aggregate each CPRS component into pool tables based on user pooling filters, (c) aggregate each pool's components and (d) calculate the terms for each pool;
electronically transmitting over a computer network, in a predefined format, to a plurality of users the CPRS pool information including (a) the pool terms, (b) component descriptions (c) user preference statistical information (d) settlement instructions, and (e) a unique identification code for the pool;
assigning the CPRS pool to a plurality of users wishing to aggregate Call-Put Referenced Structures in response to the user accepting the pool terms;
electronically generate and transmit reports over a computer network to a plurality of user's settlement agents, in a predefined format, information related to CPRS pool settlement instructions including (a) counterparties, (b) pool terms, (c) settlement timing and (d) the CPRS or CPRS pool's identification code;
electronically receiving from a plurality of user's agents settlement confirmation and automatically (a) re-registering the CPRS or CPRS pool for each counterparty and (b) updating the databases, if the settlement was performed.

49. The method of claim 48 wherein the steps of receiving the user's filters to form pools further includes users forming pools based on (a) property price indices, (b) statistical geographic subdivisions, (c) collateral types. (d) expiration date(s), (e) counterparties and (e) other filters.

50. The method of claim 48 wherein a convention for pooling CPRS further provides that users are permitted to aggregate CPRS (a) components, (b) portfolios, (c) previously aggregated structures or (d) any combination thereof.

51. A computer implemented method for trading Call-Put Referenced Structures (CPRS) and CPRS pools, the method comprising the steps of:
electronically receiving over a computer network, from a plurality users (a) queries regarding trading (buying and selling) of outstanding CPRS or CPRS pools, (b) user preferences for trading and (c) descriptive information related to the CPRS or CPRS pools to be traded;
electronically retrieving from a system database records of outstanding CPRS or CPRS pools to be traded comprising information related to (a) CPRS or CPRS pool terms, (b) underlying collateral descriptions and (c) CPRS counterparties;
accessing controlling logic of the system which administers conventions for trading CPRS and CPRS pools;
processing data about the database records and conventions using a computing device to calculate (a) a trade's economic value and (b) trade terms;
electronically transmitting over a computer network to a plurality of users, in a predefined format, information related to (a) counterparties descriptions, (b) the trade terms, (c) the economic values of the trade, (d) an associate collateral description and (d) settlement instructions;
assigning the trade to matched counterparties, one counterparty wishing to purchase the CPRS or CPRS pool and the other counterparty wishing to sell the CPRS or CPRS pool in response to (a) the counterparties accepting the terms of the trade and (b) the seller's accepting the buyer's price, or the buyer's accepting the seller's price;
electronically generating and transmitting reports over a computer network to a plurality of user's settlement agents, in a predefined format, information related to CPRS or CPRS pool trade settlement instructions including (a) counterparties, (b) CPRS or CPRS pool terms, (c) the trade's economic values, (d) settlement timing and (e) the pool's identification code;
electronically receiving from a plurality of user's agents settlement confirmation and automatically (a) registering the CPRS pools for each counterparty and (b) update the databases, if the settlement was performed.

52. The method of claim 51 wherein the receiving descriptive information of the instruments includes collecting a unique identification code.

53. The method of claim 51 wherein the conventions for trading Call-Put Referenced Structures include that they may be traded between two counterparties (a) on a negotiated basis, (b) through an exchange, (c) over the counter using a brokerage house or (d) using another suitable service provider that can facilitate the settlement of the trade.

54. The method of claim 51 wherein a convention for trading Call-Put Referenced Structure is that structures secured by real estate are (a) eligible to be traded, (b) may be traded independent of any changes in the subject property, (c) in conjunction with a mortgage debt restructuring of the subject property or (d) in conjunction with the sale of the subject property.

55. The method of claim 51 wherein processing the data to calculate the trade's economic values is performed using property price indicies.

56. A computer implemented method for automatically administering expiration of a Call-Put Referenced Structures (CPRS), the method comprising:
automatically executing an expiration application to run queries against a CPRS Terms database to identify CPRS's that are expiring within user defined time periods;
electronically retrieving from a system database records of the expiring CPRSs comprising information related to the (a) users (b) counterparties, (c) real estate collateral, (d) terms and (e) pools.
accessing the application software which administers the controlling logic and conventions for expiring CPRS;
processing the data from the database records using a computing device to calculate an intrinsic value due at expiration;
electronically generating and transmitting reports over a computer network to a plurality of users, in a predefined format, information related to CPRS expirations including (a) expiration date, (b) counterparty descriptions, (c) CPRS terms (d) the referenced property price index description and (e) the intrinsic value;
assigning the expiration terms to matched counterparties, one counterparty liable for the intrinsic value, the other counterparty due to receive the intrinsic value, upon receipt of from each counterparty confirmation of the expiration terms;
electronically generating and transmitting reports over a computer network to a plurality of user's settlement agents, in a predefined format, information related to CPRS expiration settlement instructions including (a) counterparties, (b) expiration terms, (c) intrinsic value, (d) expiration timing, (e) settlement instructions and (f) unique identification code for the CPRS;
electronically receiving from a plurality of user agents settlement confirmation and automatically updating the databases if the settlement was performed.

57. The method of claim 56 wherein the processing the data to calculate the intrinsic value values due at expiration being performed using a property price indicies.

58. The method of claim 56 wherein the generating and transmitting reports to users and user's settlement agents comprising calculating a pro-rata share of the intrinsic value for each owner of a CPRS pool.

59. A computer implemented method for identifying current, historic and future Call-Put Referenced Structures (CPRS) information corresponding to a search request, the method comprising the steps of:
maintaining the CPRS configuration library, site hierarchy and database;
maintaining a plurality of search listings associated with users search and reporting criteria;
electronically receiving over a computer network, from a plurality users search requests with at least one search term to provide users: (a) CPRS and CPRS pools descriptive information, (b) valuations, (c) audit reports, (d) historical activity and (e) projected future activity;
electronically retrieving database records related to CPRS and CPRS pools that match the search request;
accessing application software which administers conventions for searching and ordering an identified search;
processing the data using a computing device to automatically generate a requested search listing related to (a) CPRS, (b) portfolios of CPRS, (c) pools of CPRS and (d) related history;
electronically transmitting over a computer network, in a predefined format, to a plurality of users system generated reports.

60. The method of claim 59 wherein the receiving user search request regarding Call-Put Referenced Structures includes collecting the CPRS or CPRS pool's (a) unique identification codes and (b) appended identification codes.

61. The method of claim 59 wherein the steps in receiving queries regarding search requests further includes information related to (a) scheduled maturities, (b) CPRS trends, (c) CPRS relative value, (d) CPRS performance and (e) projected performance.

62. The method of claim 61 wherein performance may be measured by the performance of the referenced property price index.

63. The method of claim 59 wherein the steps in retrieving the property price indices comprises collecting the historic and current values for (a) property price indices, (b) derivative property price indices and (c) referenced property price indices.

64. The method of claim 59 wherein the steps in generating the requested search is for specific time periods.

65. The method of claim 59 wherein the steps in generating the requested search may be performed on a scheduled periodic basis or an ad-hoc search.

66. A computer based system for referencing property price indices to real estate parcels, calculating the values for CPRSs and managing CPRS events, the system comprising:
a server system linked to a plurality of users systems, interconnected and providing communications access through a plurality of networks;
network input and output devices coupled to the central processor for processing communication input messages and output messages between a plurality of users;
a central processing unit for manipulation of input data and system databases in accordance with system controlling logic;
a plurality of application software components coupled to the central processor, residing on a computer readable storage medium, at least one of the plurality of software components configured to; (a) create derivative property price indices, (b) calculate statistical association between a plurality of property price indices and derivative property price indices, (b) reference associated property price indices to real estate parcels, (c) calculate the intrinsic value of a CPRS, (d) calculate the time value of a CPRS (e) calculate the terms of the CPRS and CPRS pools, (f) manage counterparty registration and (g) manage the schema of the database for CPRS;
communications software coupled to the application software for (a) executing requests from the application software to obtain input data from the networks and send output data to the networks (b) monitor the service providers network for updates to user independent data and (c) monitor the user networks to receive queries and event requests;
a computer readable memory storage device coupled to the central processor for storing data pertaining to (a) property price indices, (b) derivative property price indices, (c) associated property price indices, (d) referenced property price indices, (e) counterparties, (f) CPRS unit terms, (g) CPRS pool terms, (h) CPRS collateral, (i) statistical geographical subdivisions, (j) capital markets data, (k) CPRS users and (l) CPRS event history.

67. The system of claim 66 wherein said output messages include periodic reports referencing CPRS events.

68. The system of claim 66 wherein said system controlling logic includes (a) users event rights, (b) event processes and (c) CPRS conventions.

69. The system of claim 66 wherein said application software for calculating the time value and the intrinsic value of CPRS includes using referenced property price index data as inputs for all capital asset valuation models.
